(19) United States
(12) Patent Application Publication
(10) Pub. No.: US 2026/0140368 A1
(43) Pub. Date: May 21, 2026

(54) OPTICAL SYSTEM AND DISPLAY APPARATUS

(71) Applicant: CANON KABUSHIKI KAISHA, Tokyo (JP)

(72) Inventors: Ryota OTSUBO, Tokyo (JP); Keiichiro ISHIHARA, Saitama (JP)

(21) Appl. No.: 19/338,012

(22) Filed: Sep. 24, 2025

(30) Foreign Application Priority Data
Nov. 15, 2024 (JP) 2024-200088

(51) Int. Cl. G02B 27/00; G02B 27/01; G02B 27/28

(52) U.S. Cl. CPC G02B 27/0081; G02B 27/0172; G02B 27/283; G02B 2027/013

(57) ABSTRACT

An optical system includes a projection unit configured to project light from a display element to form a first pupil, and a light guide element configured to guide light from the projection unit to an eyepoint. The light guide element includes a reflector configured to form a second pupil at the eyepoint. The reflector includes a plurality of reflective surface pairs, each consisting of a first reflective surface and a second reflective surface. Predetermined inequalities are satisfied.

### BACKGROUND

### Field of the Technology

The aspect of the disclosure relates to one or more embodiments of an optical system and a display apparatus.

### Description of the Related Art

Observation optical systems having a light guide plate such as a half-mirror laminated type light guide plate or a diffractive light guide plate have conventionally been known, and are used for Augmented Reality (AR) glasses and the like. Regarding a light guide element for a virtual image display apparatus that guides image light from a display element and emits it to display a virtual image, Japanese Patent Application Laid-Open No. 2024-65027 discloses a pupil-conjugate light guide plate that improves light utilization efficiency by using a recursive mirror to collect a widely spread light beam from a projection unit onto the observer's pupil. Regarding a light guide that guides image light from a display element to an observer, PCT International Publication No. WO 2019/120839 discloses an optical deflector that couples the image light to be guided and spread within a light guide member of the light guide.

### SUMMARY

One or more embodiments of an optical system according to one or more aspects of the disclosure may include a projection unit configured to project light from a display element to form a first pupil, and a light guide element configured to guide light from the projection unit to an eyepoint. The light guide element includes a reflector configured to form a second pupil at the eyepoint. The reflector includes a plurality of reflective surface pairs, each consisting of a first reflective surface and a second reflective surface. In a first cross section including a normal to each of the first reflective surface and the second reflective surface, the following inequalities are satisfied with respect to a principal ray at a central angle of view:

$$0 \leq \vert α \vert \leq 20$$

$$0 \leq \vert β \vert \leq 20$$

where α (*) is an angle between light incident on the first reflective surface and the second reflective surface, and β (*) is an angle between light reflected by the second reflective surface and the first reflective surface. Alternatively, the following inequality is satisfied:

$$50 \leq \vert θ \vert \leq 70$$

where θ (°) is an angle between the first reflective surface and the second reflective surface. One or more display apparatuses may include one or more optical systems in accordance with one or more other aspects of the disclosure.

Features of the disclosure will become apparent from the following description of embodiments with reference to the attached drawings. The following description of embodiments will be provided by way of example.

### BRIEF DESCRIPTION OF THE DRAWINGS

FIG. 1 is a perspective view of a display apparatus according to a first embodiment.

FIG. 2 is a perspective view illustrating a positional relationship of each optical element in the first embodiment.

FIG. 3 is a sectional view of a projection unit in each embodiment.

FIGS. 4A and 4B are sectional views of an image extractor in each embodiment.

FIGS. 5A and 5B are sectional views of a pupil reconstruction mirror in each embodiment.

FIGS. 6A, 6B, 6C, 6D, and 6E explain a mirror pair in each embodiment and a mirror pair in a comparative example.

FIGS. 7A and 7B are sectional views of the pupil reconstruction mirror in each embodiment and a pupil reconstruction mirror in the comparative example.

FIGS. 8A and 8B illustrate a relationship between an angle formed by the mirror pair and a ratio of light beam after reflection in each embodiment.

FIGS. 9A, 9B, and 9C are sectional views of the mirror pair according to a variation of each embodiment.

FIG. 10 is a perspective view of an observation optical system according to a second embodiment.

FIGS. 11A, 11B, and 11C are sectional views of a pupil reconstruction mirror according to a third embodiment.

FIGS. 12A, 12B, and 12C are sectional views of a pupil reconstruction mirror according to a fourth embodiment.

FIGS. 13A and 13B are sectional views of a pupil reconstruction mirror according to a fifth embodiment.

FIGS. 14A and 14B are sectional views of a pupil reconstruction mirror according to a sixth embodiment.

### DESCRIPTION OF THE EMBODIMENTS

Referring now to the accompanying drawings, a detailed description will be given of embodiments according to the disclosure. Corresponding elements in respective figures will be designated by the same reference numerals, and a duplicate description thereof will be omitted.

### First Embodiment

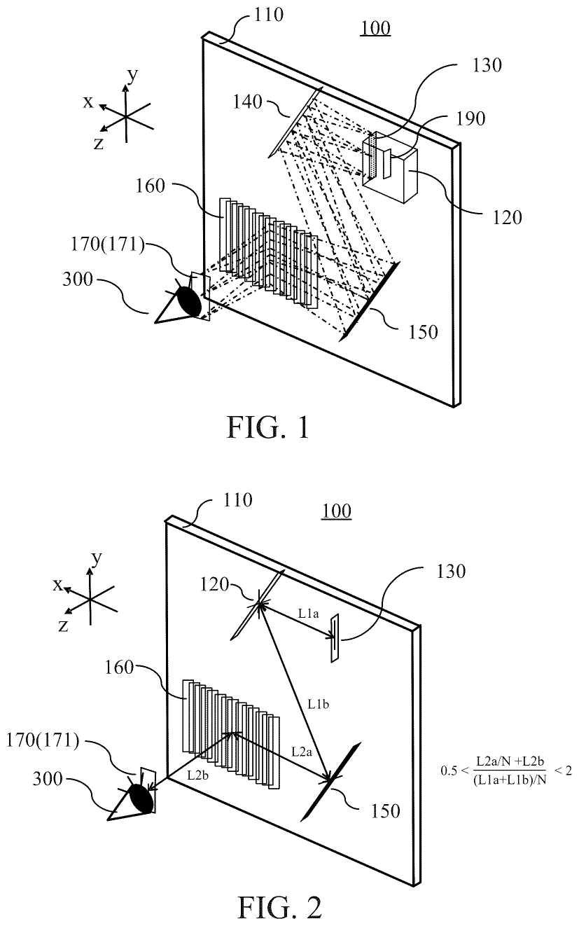

First, a display apparatus 100 according to this embodiment will be described with reference to FIG. 1. FIG. 1 is a perspective view of the display apparatus 100. The display apparatus 100 includes a display element 190 and an optical system (observation optical system) that guides light from the display element 190 to an eyepoint (pupil in the eye of an observer 300) 170.

The display apparatus 100 further includes a light guide plate (light guide element) 110, a projection unit 120, a first pupil (exit pupil) 130 formed by the projection unit 120, a folding (or turn-back) mirror 140, a pupil reconstruction mirror (reflector) 150, and an image extractor (extractor, light guide unit) 160. The folding mirror 140 is a deflective element that causes light from the projection unit 120 to be incident parallel to a mirror surface of a second mirror of the pupil reconstruction mirror 150 with respect to the principal ray at the central angle of view, and is disposed to allow light from the first pupil 130 to enter the pupil reconstruction mirror 150 at a desired angle. However, in this embodiment, the folding mirror 140 is not essential. Instead of providing the folding mirror 140, for example, the position of the first pupil 130 may be adjusted so that the light from the first pupil 130 directly enters the pupil reconstruction mirror 150.

The light guide plate 110 guides light from the projection unit 120 to the eyepoint 170 of the observer 300. That is, the light guide plate 110 is configured to form a second pupil 171, which is a reconstruction of the first pupil 130, at the position of the pupil (eyepoint 170) of the observer 300 in the z direction in FIG. 1.

The projection unit 120 projects light from the display element 190 to form the first pupil 130. A light beam that enters the light guide plate 110 from the first pupil 130 formed by the projection unit 120 is filled in an area equivalent to the thickness of the light guide plate 110 in the thickness direction of the light guide plate 110. In the width direction of the light guide plate 110, a light beam having a light beam width narrower than the width of the light guide plate 110 travels inside the light guide plate 110 while the light beam is internally reflected. This light beam's traveling direction varies according to an angle of view, and thus the light beam travels from the first pupil 130 with a spread corresponding to the angle of view. The light that travels while being internally reflected is deflected by the folding mirror 140 and enters the pupil reconstruction mirror 150.

The pupil reconstruction mirror 150 is disposed outside a see-through area, and its reflectance may be 80% or more, or 90% or more. Using the pupil reconstruction mirror 150 can set a reflectance higher than that of a half-mirror.

The light that enters the pupil reconstruction mirror 150 is reflected at a different angle so as to form a second pupil 171 while being deflected in the x direction. The reflected light is extracted (guided) to the outside of the light guide plate 110 by the image extractor 160 before the second pupil 171 is formed, and forms the second pupil 171 at the position of the eyepoint 170 of the observer 300.

Thus, in this embodiment, the pupil reconstruction mirror 150 forms the second pupil 171 at the eyepoint 170, and the image extractor 160 extracts the light to the outside of the light guide plate 110 (guiding the light from the pupil reconstruction mirror 150 to the eyepoint). In this embodiment, the pupil reconstruction mirror 150 and the image extractor 160 are configured as separate entities.

Referring now to FIG. 2, a description will be given of a positional relationship of the optical elements to achieve pupil reconstruction. Now assume that A1 (mm) is an air-equivalent distance from the position of the pupil reconstruction mirror 150 to the position of the first pupil 130 formed by the projection unit 120, and A2 (mm) is an air-equivalent distance from the position of the pupil reconstruction mirror 150 to the position of the eyepoint 170. The eyepoint 170 is the position where the second pupil 171 is formed. The eyepoint 170 is disposed, for example, at a distance of approximately 12 mm to 18 mm from the exit surface of the light guide plate 110 (so that the eye relief is 12 mm to 18 mm). However, this embodiment is not limited to this example and can be changed according to the size of the display apparatus 100, whether it is compatible with vision correction glasses, and the like.

Now assume that L1a is a distance from the center of the first pupil 130 inside the light guide plate 110 to the center position of the folding mirror 140, and L1b is a distance from the position of the folding mirror 140 inside the light guide plate 110 to the position of the pupil reconstruction mirror 150. In this embodiment, the position of the pupil reconstruction mirror 150 is the center of the pupil reconstruction mirror 150, which corresponds to the eye height of the observer 300. This position may also be the position where the principal ray at the central angle of view reaches the image extractor 160. Nis a refractive index of the light guide plate 110 for the d-line. In this case, the air-equivalent distance A1 is expressed as:

$$A 1 = ( L 1 a / N ) + ( L 1 b / N ) .$$

The air-equivalent distance A2 is expressed as:

$$A 2 = ( L 2 a / N ) + L 2 b$$

where L2a is a distance from the position of the pupil reconstruction mirror 150 inside the light guide plate 110 to the center position of the image extractor 160 and L2b is a distance in air from the exit surface of the light guide plate 110 to the eyepoint 170.

In this embodiment, in order to reconstruct the first pupil 130 formed by the projection unit 120 at the eyepoint 170 (to achieve the pupil reconstruction), the relationship between the air-equivalent distances A1 and A2 may satisfy the following inequality (1):

$$0.5 < A 2 / A 1 < 2.0 \qquad ( 1 )$$

In a case where A2/A1 becomes higher than the upper limit of inequality (1), the pupil is formed in front of the eye of the observer 300, preventing the image from being viewed at a wide angle (a simultaneously viewable angle of view becomes narrower). On the other hand, in a case where A2/A1 becomes lower than the lower limit of inequality (1), the pupil is formed behind the eye of the observer 300, preventing the image from being viewed at a wide angle (the simultaneously viewable angle of view becomes narrower). Regarding the distance L1b, in a case where the light guide plate 110 includes a plurality of recursive mirrors, inequality (1) may be satisfied for the distance L1b to all (e.g., three) recursive mirrors (e.g., the distance to the center of a single recursive mirror).

Inequality (1) may be replaced with inequality (1a) below:

$$0.6 < A 2 / A 1 < 1.5 \qquad ( 1 a )$$

Inequality (1) may be replaced with inequality (1b) below:

$$0.8 < A 2 / A 1 < 1.2 \qquad ( 1 b )$$

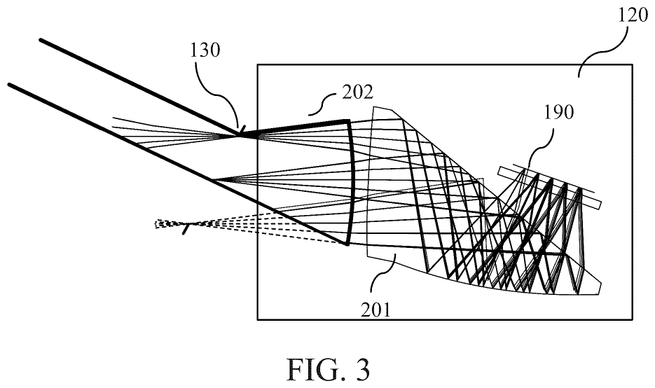

Referring now to FIG. 3, a description will be given of the function of the projection unit 120. FIG. 3 is a sectional view of the projection unit 120. The projection unit 120 includes a display element 190, such as an organic light-emitting diode (OLED), and a projection optical system. The projection optical system includes a free-form prism 201, achieving a wide acceptance angle and compact size. However, this embodiment is not limited to this example, and the projection unit 120 may use a general optical system instead of the free-form prism 201.

In this embodiment, the projection unit 120 forms the first pupil 130 inside the light guide plate 110, and folds the pupil when the light enters a head 202, thereby filling the light beam propagating within the light guide plate 110 without any gaps. Due to this configuration, the light beam is extracted by the image extractor 160 without any light beam leakage, and a good image can be provided to the observer 300.

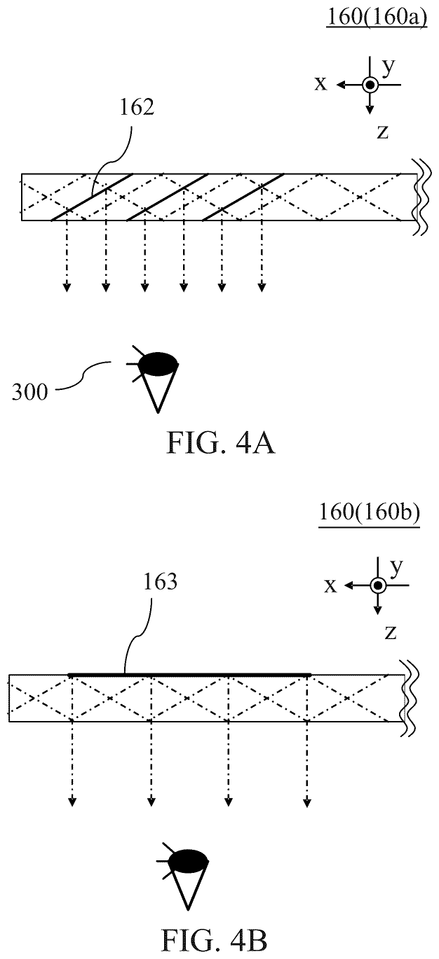

Next, the image extractor 160 (160a, 160b) will be described with reference to FIGS. 4A and 4B. FIG. 4A is a sectional view of the image extractor 160 (160a) in this embodiment. FIG. 4B is a sectional view of the image extractor 160 (160b) according to a variation of this embodiment.

As illustrated in FIG. 4A, the image extractor 160 (160a) in this embodiment has an insert mirror 162. Since the insert mirror 162 is disposed in the see-through area, from the perspective of the transmittance of the AR glass, the transmittance of the insert mirror 162 may be 80% or more, or 90% or more. The insert mirror 162 is disposed without any gaps in the line-of-sight direction of the observer 300, and can extract light for the observer 300 without any light beam leakage.

As illustrated in FIG. 4B, the image extractor 160b may be formed by applying a diffraction grating or hologram to a surface 163 of the light guide plate 110. Due to this configuration, the diffraction grating or hologram can be disposed without any gaps in the line-of-sight direction of the observer 300. In this variation, from the perspective of transmittance, the transmittance of the see-through may be 80% or more, or 90% or more.

In either configuration, in this embodiment, the optical paths before and after the pupil reconstruction mirror 150 are separated. Hence, the image extractor 160 can be filled without any gaps in the line-of-sight direction of the observer 300, and a good image can be provided to the observer 300.

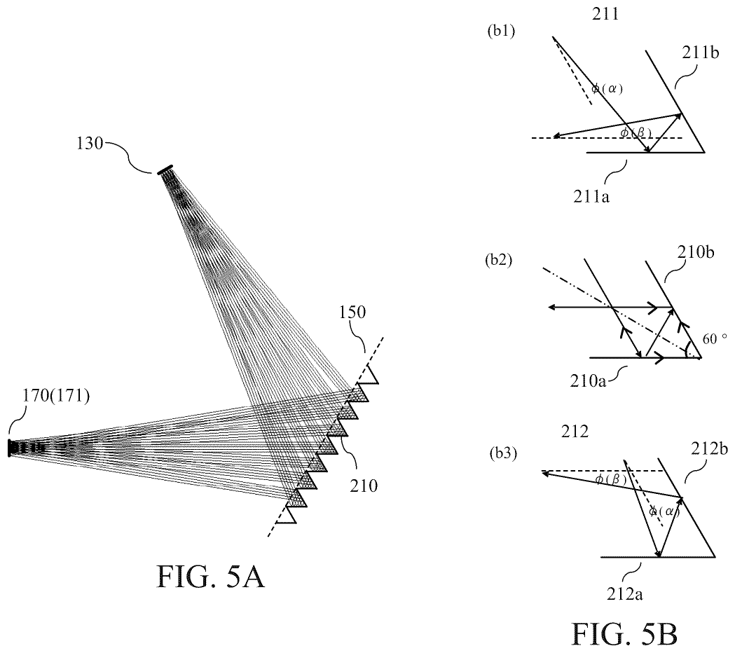

Next, the configuration of the pupil reconstruction mirror 150 in this embodiment will be described with reference to FIGS. 5A and 5B. FIGS. 5A and 5B are sectional views of the pupil reconstruction mirror 150.

FIG. 5A extracts the first pupil 130, the pupil reconstruction mirror 150, and eyepoint 170 (second pupil 171) from FIG. 1. The pupil reconstruction mirror 150 includes a plurality of mirror groups (a plurality of reflective surface pairs). Each of the plurality of mirror groups is a mirror pair (reflective surface pair) 210 that includes a first mirror (first reflective surface) and a second mirror (second reflective surface) (opposite to or adjacent to each other).

In a predetermined cross section (first cross section: cross section illustrated in FIGS. 5A and 5B) that includes the normal to the mirror surface of each of the first mirror and the second mirror, θ (°) is an angle between the first mirror and the second mirror. The pupil reconstruction mirror 150 includes a mirror group in which a plurality of mirror pairs 210, each having two mirrors arranged at an angle θ relative to each other, are arranged in the planar direction of the light guide plate 110.

In this embodiment, the angle θ between the two mirror surfaces of the mirror pair 210 (mirror surfaces 210a and 210b in (b2) of FIG. 5B) that are the same length is set to 60 degrees, and a plurality of mirror pairs 210 are arranged along a line segment connecting the mirror ends. FIGS. 5A and 5B illustrate a state in which θ is 60 degrees. However, this embodiment is not limited to this example, and the plurality of mirror groups may include at least two mirror groups that satisfy the inequality 50≤|θ|≤70 or 55≤|θ|≤65.

Light from the first pupil 130 travels with a spread angle ±φ corresponding to the angle of view based on the traveling direction at the central angle of view. In this embodiment, angle q has angle information in the vertical direction, and the angle of view in the vertical direction at the eyepoint 170 can be expressed as 2Nφ using the refractive index N of the light guide plate 110. This light with a spread of ±φ is reflected twice by the surfaces of the mirror pair 210 that constitutes the pupil reconstruction mirror 150, while being converged and reflected to form the second pupil 171.

FIG. 5B illustrates how the central angle of view and angle-of-field light beams that spread vertically by an angle φ are reflected by the pupil reconstruction mirror 150. The mirror pair 210 is arranged so that the first mirror surface and the second mirror surface face each other. The mirror surfaces of the first mirror and the second mirror are arranged so that light at the central angle of view is incident parallel to the mirror surface of the second mirror and reflected parallel to the mirror surface of the first mirror.

The light at the central angle of view that is incident on the pupil reconstruction mirror 150 is reflected twice, by the mirror surface (first reflective surface) 210a of the first mirror and the mirror surface (second reflective surface) 210b of the second mirror, thereby changing its course in the horizontal direction.

(b1) in FIG. 5B illustrates the reflection of light that has entered an upper mirror pair 211 of the pupil reconstruction mirror 150, out of light that has spread by +φ relative to the central angle of view. A dotted line in the figure indicates a light traveling direction at the central angle of view. The light that has spread by angle φ relative to the central angle of view is reflected twice by a mirror surface (first reflective surface) 211a of the first mirror and a mirror surface (second reflective surface) 211b of the second mirror, thereby changing its course in a converging direction at the angle φ relative to the central angle of view.

(b3) in FIG. 5B illustrates the reflection of light that has entered a lower mirror pair 212 of the pupil reconstruction mirror 150, among the spread angle of view. As in (b1), the light that has spread by the angle φ relative to the central angle of view is reflected twice by a mirror surface (first reflective surface) 212a of the first mirror and a mirror surface (second reflective surface) 212b of the second mirror, thereby changing its course in a converging direction at the angle φ relative to the central angle of view. Thus, the pupil reconstruction mirror 150, which includes the mirror pairs 210 with the same angle between them, can converge the expanded angle-of-field light beam while maintaining the angle information (angle q) relative to the central angle of view, and can form the second pupil 171.

In this embodiment, α (°) is an angle between the light incident on the first mirror and the mirror surface of the second mirror, and β (°) is an angle between the light reflected by the second mirror and the mirror surface of the first mirror. Then, FIG. 5B illustrates a state in which α=0 and β=0. However, this embodiment is not limited to this example. For example, the mirrors may be arranged so that the inequalities 0≤|α|≤20 and 0≤|β|≤20 are satisfied for the principal ray at the central angle of view.

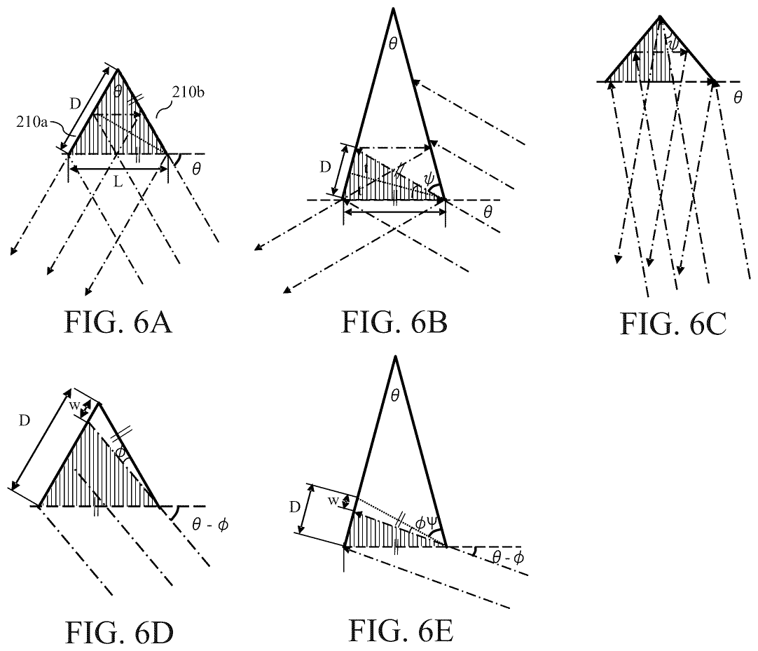

Referring now to FIGS. 6A, 6B, 6C, 6D, and 6E, a description will be given of a relationship between the angles of the incident light and reflected light relative to the mirror and the light beam width. FIG. 6A illustrates a state when the mirror surfaces are arranged so that the light incident on mirror surface 210a of the first mirror is parallel to the mirror surface 210b of the second mirror, and the light reflected from the mirror surface 210b of the second mirror is parallel to the mirror surface 210a of the first mirror. In this configuration, the angle θ between mirror pair 210 is 60°. Lis an opening of the mirror pair 210, and D is a beam width on the effective mirror surface for reflection.

As illustrated in FIG. 6A, light enters parallel to mirror surface 210b of the second mirror, and can hit the entire mirror surface 210a of the first mirror, allowing for a large effective mirror surface. In this case, a triangle (beveled portion) formed by the light incident on the opening L and the beam width (effective diameter) D on the effective mirror surface is an isosceles triangle with two sides L. Therefore, the beam width D is expressed by the angle θ between the mirror pair 210 as illustrated in equation (2):

$$D = L * sin ( θ / 2 ) * 2 \qquad ( 2 )$$

In FIG. 6A, the beam width D is the same length as the opening L of the mirror pair 210. The light reflected and emitted from the mirror surface 210b of the second mirror and the mirror surface 210a of the first mirror are parallel to each other. Thus, the light can be reflected without being hindered by the mirror surface 210a of the first mirror.

FIG. 6B illustrates a comparative example in which the mirror surfaces are arranged so that φ=45°, where φ is an angle of light relative to each mirror surface. In this configuration, the angle θ between the mirror pair is 30°. When the light is incident at an angle to the mirror surface of the second mirror, as in this configuration, the shadow cast by the mirror surface of the second mirror prevents the light incidence, reducing the beam width D on the effective mirror surface. In this case, the light beam width D is D=L*sin (30/2)*2=0.52L, which is half the effective diameter for θ=60°.

FIG. 6C illustrates a comparative example in which the light angle φ is set in a direction opposite to that of FIG. 6B, and the mirror surfaces are arranged so that φ=30°. In this configuration, the angle θ between the mirror pair is 80°. The light incident at this angle hits not only the mirror surface of the first mirror but also the mirror surface of the second mirror, generating stray light and preventing all light that enters the opening L from being properly reflected. Hence, light beam leakage occurs at all angles of view, resulting in image quality degradation across the total angle of view.

FIGS. 6D and 6E illustrate the light beam widths on the mirror surfaces when light is incident at an angle (angle of view) φ relative to the central angle of view for a mirror pair set under the incidence conditions illustrated in FIGS. 6A and 6B. In this case, it is understood that the light beam width on the mirror surface is reduced by w compared to the light beam width D in FIG. 6A. The reduction amount w is expressed as follows (3) using the angle (angular shift amount) φ:

$$w \approx L * cos φ \qquad ( 3 )$$

In other words, it is understood that the reduction amount w in the light beam width is determined by the angle (angular shift amount) q, regardless of the angle θ. Since the ratio of beam leakage is w/D, the larger the beam width D without light beam leakage is, the smaller the influence of beam leakage is. The beam width Dis maximized in a case where the light incident on the mirror surface of the first mirror is parallel to the mirror surface of the second mirror, and the light reflected from the mirror surface of the second mirror is parallel to the mirror surface of the first mirror, that is, in a case where θ=60°. Therefore, the optimal arrangement for the mirror pair 210 is θ=60°.

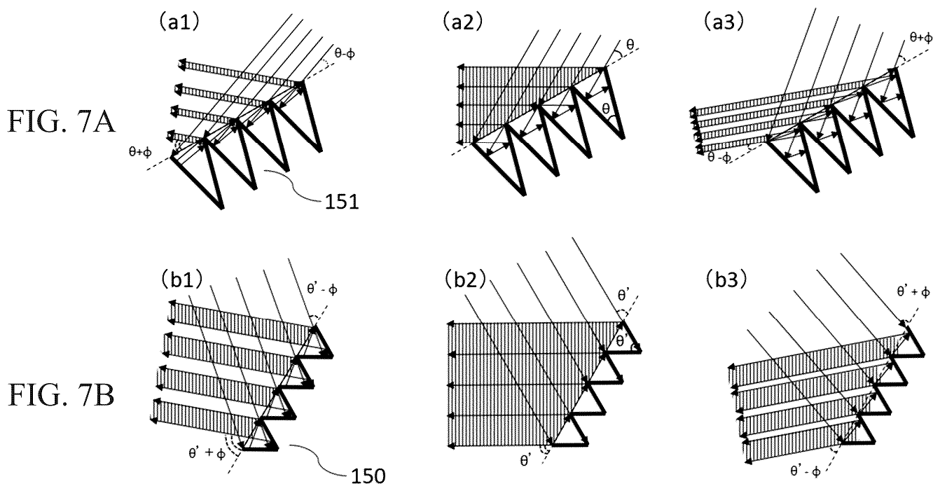

FIGS. 7A and 7B illustrate the reflection when a plurality of mirror pairs are arranged. FIG. 7A illustrates a comparative example in which an angle between the mirror pair of the pupil reconstruction mirror 151 is 30 degrees ((a1) to (a3)). FIG. 7B illustrates a comparative example in which an angle between the mirror pair of the pupil reconstruction mirror 150 is 60 degrees ((b1) to (b3)). Each figure illustrates the reflections of light beams traveling at the central angle of view and at angles ±φ away from the central angle of view.

When FIGS. 7A and 7B are compared at the same angle change, it is understood that while a light beam escape amount does not change significantly, the entire light beam ratio is greater at θ=60°. This is because, as illustrated in FIGS. 7A and 7B, for light at the central angle of view, the size of the light beam reflected from one mirror pair is greater at θ=60° than at θ=30°.

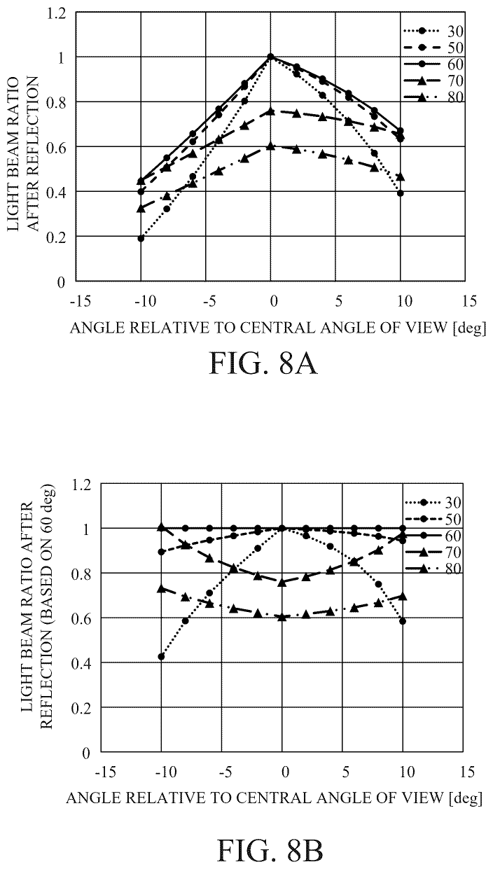

FIGS. 8A and 8B are graphs plotting a relationship between an angle relative to the central angle of view and a filling ratio of a light beam after reflection, for each angle θ between the mirror pairs. In FIG. 8A, the horizontal axis represents the angle (°) relative to the central angle of view, and the vertical axis represents the light beam ratio after reflection. In FIG. 8B, the horizontal axis represents the angle (°) relative to the central angle of view, and the vertical axis represents the light beam ratio after reflection (based on 60°).

Currently, the AR glasses with a generally wide angle of view have a diagonal angle of view of 50° or more. If the display aspect ratio is 4:3, the refractive index of the light guide plate N=1.5, angle-of-view information in the horizontal direction is set to a propagation angle in the thickness direction, and angle-of-view information in the vertical direction is set to the planar direction, the angle-of-view light beam propagating within light guide plate 110 is approximately ±10° in the planar direction. Based on the above information into consideration, FIGS. 8A and 8B illustrate an angle range of ±10°. In a case where θ is 60° or less (dotted graph with black dots plotted), it is understood that the light-beam filling ratio significantly decreases as the angle of view moves away from the central angle of view, and becomes maximum at 60°. On the other hand, when θ is greater than 60° (dotted graph with black triangles plotted), light beam leakage occurs even at the central angle of view, but the ratio decrease is gradual since light beam leakage is less likely to occur when θ is less than 60°.

In this embodiment, the range of the angle θ can be selected properly according to the purpose of use of the AR glasses. For example, for uniform display across a wide angle of view, such as in a monitor, light beam leakage must be suppressed from the central angle of view to a high angle-of-view range. In this case, a range of 60<θ≤70 may be used, which can suppress light beam leakage even further to the high angle-of-view side. The mirror surfaces are arranged so that an angle of the light incident on the mirror surface of the first mirror relative to the mirror surface of the second mirror is within 20° or 15°, and an angle of the light reflected from the second mirror surface relative to the mirror surface of the first mirror is within 20° or 15°.

A range of 60<θ≤65 may be used, because this range can suppress the influence of light beam leakage even near the central angle of view. In this case, the mirror surfaces are arranged so that an angle of the light incident on the mirror surface of the first mirror relative to the mirror surface of the second mirror is within 7.5°, and an angle of the light reflected from the mirror surface of the second mirror relative to the mirror surface of the first mirror is within 7.5°.

In a case where display is primarily in the central portion of the screen, as in navigation, it is necessary to minimize light beam leakage near the central angle of view. In this case, a range of 50≤0≤60 may be used, which suppresses light beam leakage at the central angle of view and limits the influence on a high angle-of-view side to approximately 10% of θ=60. In this case, the mirror surfaces are arranged so that an agnel of the light incident on the mirror surface of the first mirror relative to the mirror surface of the second mirror is within 20° or 15°, and an angle of the light reflected from the mirror surface of the second mirror relative to the mirror surface of the first mirror is within 20° or 15°.

A range of 55≤θ≤60 may be used, because it can suppress image quality degradation even at a higher angle of view. In this case, the mirror surfaces are arranged so that an angle of the light incident on the mirror surface of the first mirror relative to the mirror surface of the second mirror is within 7.5°, and an angle of the light reflected from the mirror surface of the second mirror relative to the mirror surface of the first mirror is within 7.5°.

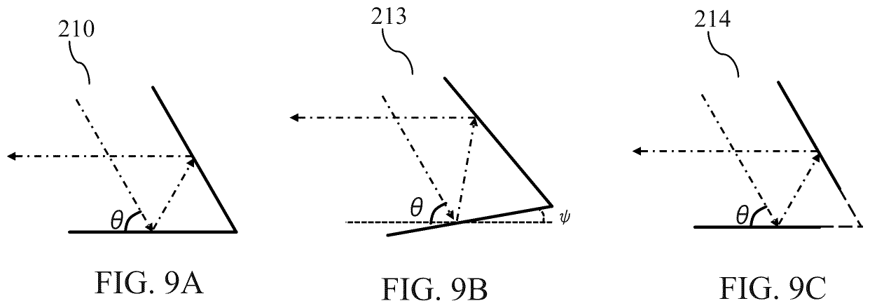

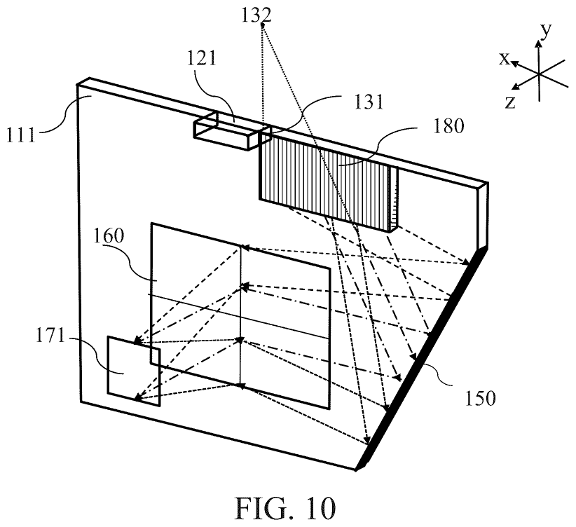

Referring now to FIGS. 9A, 9B, and 9C, a description will be given of a variation of the mirror pair constituting the pupil reconstruction mirror according to this embodiment. FIG. 9A is a sectional view of mirror pair 210 in this embodiment. FIG. 9B is a sectional view of a mirror pair 213 in a first variation. FIG. 9C is a sectional view of a mirror pair 214 in a second variation.

As with the mirror pair 213 in FIG. 9B, a light reflection direction does not change even if the mirror pair is tilted by φ as long as the angle θ is maintained. This arrangement method may be used in the variation described below to further reduce light beam leakage. As with the mirror pair 214 in FIG. 9C, the mirror pair may not contact each other. Pupil reconstruction can be similarly achieved as long as a vertex is formed on a line segment of the mirror and the angle between them is θ. Thus, in this embodiment, as long as the angle θ formed by the mirror pair is fixed, the arrangement and length of the mirror pair are not limited.

### Second Embodiment

Next, a second embodiment of the disclosure will be described with reference to FIG. 10. FIG. 10 is a perspective view of an optical system (observation optical system) according to this embodiment. The first embodiment has discussed a configuration in which the angle-of-view light beam emitted from the first pupil 130 enters the pupil reconstruction mirror 150 at a proper angle by using the folding mirror 140. On the other hand, this embodiment will discuss a configuration in which light from the first pupil 131 directly enters the pupil reconstruction mirror without using a folding mirror.

The optical system according to this embodiment includes a light guide plate 111, a projection unit 121, a first pupil 131 formed by the projection unit 121, a pupil expansion system 180 for expanding the first pupil 131, a pupil reconstruction mirror 150, and an image extractor 160. The light emitted from the first pupil 131 is set in advance so that the central angle-of-view light beam is at an optimal angle to the pupil reconstruction mirror 150. Thereafter, the pupil expansion system 180 expands the pupil diameter while maintaining the propagation angle of the angle-of-view light beam.

The pupil expansion system 180 is used to enlarge the eyebox of the observer and includes, for example, at least one half-mirror, expanding a light beam diameter by reflecting it multiple times with the half-mirror. The position of the first pupil 131 of the expanded angle-of-view light beam is located at a location different than that before expansion. In this embodiment, a virtual first pupil is formed near an intersection 132 between the principal ray of the central angle-of-view light beam and an extrapolated line of the first pupil 131. An air-equivalent distance A1′ calculated to achieve pupil reconstruction is expressed as A1′=L3/N, where L3 is a distance between the intersection 132 and the center of the pupil reconstruction mirror 150.

Since the first embodiment provides the folding mirror, the size of the light guide plate increases in the y direction. On the other hand, in a case where light from the first pupil directly enters the pupil reconstruction mirror as in this embodiment, deflection by the folding mirror may be omitted. This configuration can prevent the size of the light guide plate from increasing in the y direction, allowing it to be kept within a size suited to eyeglasses.

### Third Embodiment

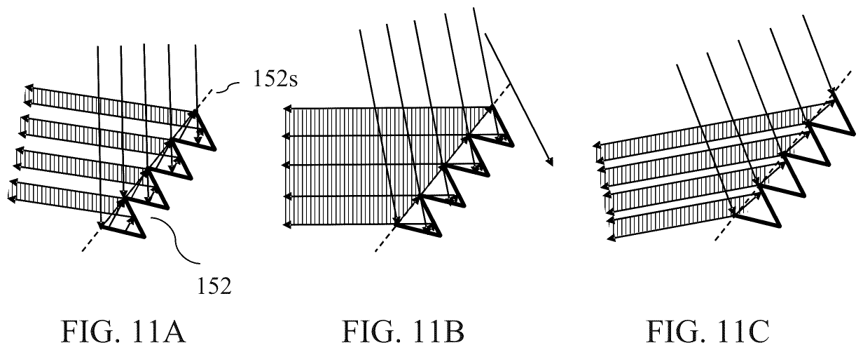

Next, a third embodiment according to the disclosure will be described with reference to FIGS. 11A, 11B, and 11C. A pupil reconstruction mirror 152 according to this embodiment is a variation of the pupil reconstruction mirror 150 according to the first embodiment. FIGS. 11A, 11B, and 11C are sectional views of the pupil reconstruction mirror 152 according to this embodiment. FIGS. 11A, 11B, and 11C illustrate the reflection in a case where the mirror surfaces are arranged so that an angle between the light incident on the mirror surface of the first mirror and the mirror surface of the second mirror is 15°, and an angle between the light reflected from the mirror surface of the second mirror and the mirror surface of the first mirror is 15°.

In this configuration, an angle between the mirror pairs is θ=50°, and FIGS. 11A, 11B, and 11C illustrate the reflections of light beams traveling at the central angle of view and angles ±φ away from the central angle of view. The pupil reconstruction mirror 152 has multiple mirror pairs arranged along a dotted line segment 152s connecting the mirror ends. As can be seen from the graph in FIG. 8B, even at θ=50 degrees, a light beam filling ratio remains approximately 90% compared to θ=60 degrees.

### Fourth Embodiment

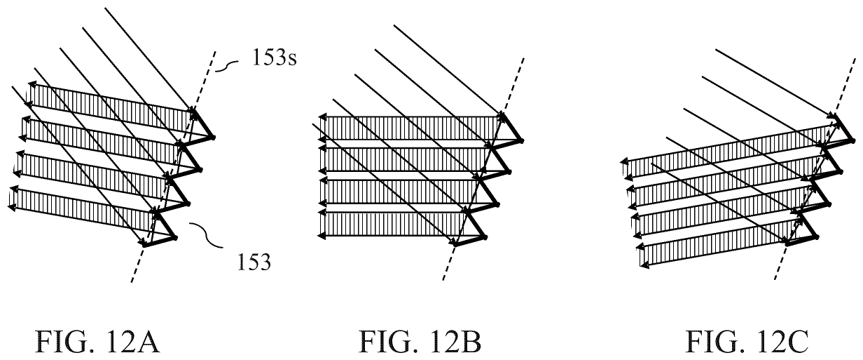

Next, a fourth embodiment according to the disclosure will be described with reference to FIGS. 12A, 12B, and 12C. A pupil reconstruction mirror 153 according to this embodiment is a variation of the pupil reconstruction mirror 150 according to the first embodiment. FIGS. 12A, 12B, and 12C are sectional views of the pupil reconstruction mirror 153 according to this embodiment. FIGS. 12A, 12B, and 12C illustrate the reflection in a case where the mirror surfaces are arranged so that an angle between the light incident on the mirror surface of the first mirror and the mirror surface of the second mirror is 15°, and an angle between the light reflected from the mirror surface of the second mirror and the mirror surface of the first mirror is 15°.

In this configuration, an angle between the mirror pair is θ=70 degrees, and FIGS. 12A, 12B, and 12C illustrate the reflections of light beams traveling at the central angle of view and angles ±φ away from the central angle of view. The pupil reconstruction mirror 153 has multiple mirror pairs arranged along a dotted line segment 153s connecting the mirror ends. In this configuration, as described with reference to FIG. 6C, even for a central angle-of-view light beam, incident light enters both mirror pairs, generating stray light that is not a normal reflection and light beam leakage in the reflected light. However, for light beams with an angle of view, the light beam is approximately the same as when θ=60 degrees.

### Fifth Embodiment

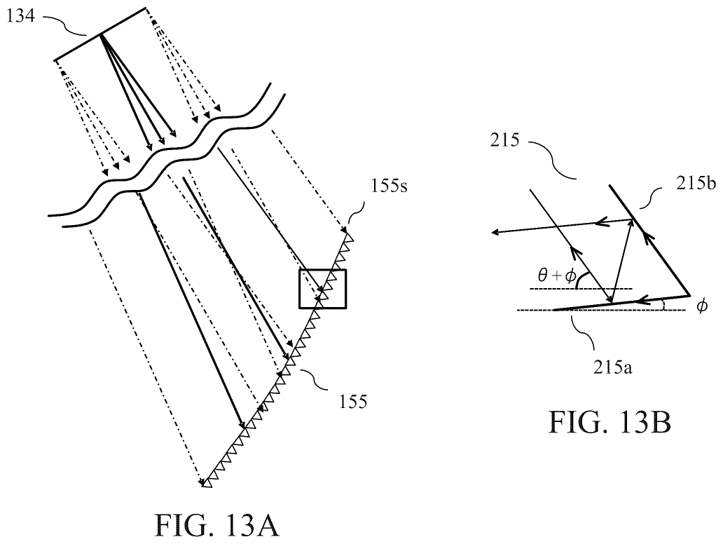

Next, a fifth embodiment according to the disclosure will be described with reference to FIGS. 13A and 13B. A pupil reconstruction mirror 155 according to this embodiment is a variation of the pupil reconstruction mirror 150 according to the first embodiment. FIGS. 13A and 13B are sectional views of the pupil reconstruction mirror 155 according to this embodiment. FIG. 13B illustrates an enlarged view of a part of FIG. 13A.

The pupil reconstruction mirror 150 according to the first embodiment has a configuration in which mirror pairs are arranged in a straight line along the line segment connecting the mirror ends. On the other hand, the mirror pair 215 of the pupil reconstruction mirror 155 according to this embodiment is arranged so that, the principal ray of each angle-of-field light beam from the first pupil 134 is parallel to the mirror surface 215b of the second mirror, and the light reflected from the mirror surface 215b of the second mirror is parallel to the mirror surface 215a of the first mirror. More specifically, the mirror pair on which the angle-of-field light beam shifted by an angle φ from the central angle-of-view light beam is incident is arranged at a tilt of φ compared to the mirror pair on which the central angle-of-view light beam is incident. This indicates that the tilt angle of the mirror pair increases as φ increases, and in a case where multiple mirror pairs are arranged, the mirror pairs are arranged to draw a curved surface rather than a linear arrangement as in the first embodiment.

In this configuration, since the optical path lengths of the light entering the upper and lower parts of the pupil reconstruction mirror 155 are different, the arrangement is not a perfect arc, but draws a line 155s whose curvature becomes gentler as it approaches the bottom. For mirror pairs outside the principal ray of the maximum angle-of-view light beam, further tilt is not necessary, so they may be arranged so that they are linearly arranged while maintaining the tilt at the maximum angle of view. That is, the mirror pairs may include either or both curved and linearly arranged portions.

In this embodiment, the tilt (orientation) of each of the multiple mirror groups in the first cross section changes according to the position. Also, in the first cross section, each of the multiple mirror groups has an arc shape (arc shape that is convex in a direction away from the first pupil) with a center close to the first pupil. In this embodiment, the multiple mirror groups do not have to be arc-shaped. For example, the curvature may be changed according to the position of the mirror group. The multiple mirror groups may include a mirror group arranged so that the curvature is zero.

As described above, the pupil reconstruction mirror 155 may have a fixed angle θ formed by the mirror pairs in the pupil reconstruction mirror 155, and pupil reconstruction can be achieved even if the tilt of the mirror pairs is changed. Furthermore, by making one mirror of the mirror pair parallel to each angle-of-view light beam, an angular relationship between the mirror pair and the angle-of-view light beam can be aligned with the angular relationship at the central angle of view, and light beam leakage is less likely to occur.

### Sixth Embodiment

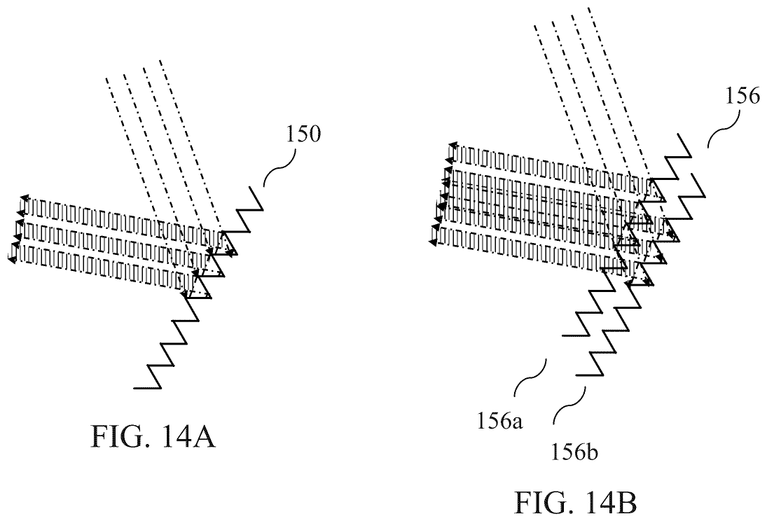

Next, a sixth embodiment of the disclosure will be described with reference to FIGS. 14A and 14B. A pupil reconstruction mirror 156 according to this embodiment is a variation of the pupil reconstruction mirror 150 according to the first embodiment. FIGS. 14A and 14B are sectional views of the pupil reconstruction mirror 156 according to this embodiment.

The first to fifth embodiments have discussed pupil reconstruction mirrors in which a plurality of mirror pairs are arranged on a single straight or curved line. On the other hand, the pupil reconstruction mirror 156 according to this embodiment has two pupil reconstruction mirrors (mirror group): a pupil reconstruction mirror (first mirror group) 156a and a pupil reconstruction mirror (second mirror group) 156b.

The mirror pair of the pupil reconstruction mirror 156a has a characteristic of reflecting only S-polarized light, and reflects only S-polarized light of unpolarized incident light toward the image extractor. On the other hand, the mirror pair of the pupil reconstruction mirror 156b has a characteristic of reflecting only P-polarized light, and reflects P-polarized light that has passed through the pupil reconstruction mirror 156a toward the image extractor. Since the light reflected by the pupil reconstruction mirror 156b is only P-polarized light, it transmits through the pupil reconstruction mirror 156a without being reflected. As a result, while light beam leakage occurs in the single the pupil reconstruction mirror 150, light beam leakage is reduced in the pupil reconstruction mirror 156 that has two mirror groups.

In this embodiment, the plurality of mirror groups include a first mirror group (first reflective surface pair) arranged in a first row and a second mirror group (second reflective surface pair) arranged in a second row in a first cross section that includes the normals to the first mirror and the second mirror. For example, the first mirror group reflects S-polarized light, and the second mirror group reflects P-polarized light. This embodiment arranges two pupil reconstruction mirrors with different deflection characteristics, and can compensate for the inherent light beam leakage. In this embodiment, the number of pupil reconstruction mirrors is not limited to two; three or more pupil reconstruction mirrors may be arranged.

To achieve an optical system with high light utilization efficiency, each embodiment may have the following characteristics: The angle α (*) between the light incident on the first mirror and the mirror surface of the second mirror, and the angle β (*) between the light reflected by the second mirror and the mirror surface of the first mirror may satisfy the following inequalities:

$$0 \leq \vert α \vert \leq 20$$

$$0 \leq \vert β \vert \leq 20.$$

They may satisfy the following inequalities:

$$0 \leq \vert α \vert \leq 15$$

$$0 \leq \vert β \vert \leq 15 .$$

They may satisfy the following inequalities:

$$0 \leq \vert α \vert \leq 7.5$$

$$0 \leq \vert β \vert \leq 7.5 .$$

They may satisfy the following equations:

$$α = 0$$

$$β = 0.$$

The mirror pair of the pupil reconstruction mirror may have a reflectivity of three times or more as large as that of the image extractor. In the first cross section, the following inequality may be satisfied:

$$0 \leq \vert γ \vert \leq 10 .$$

where γ is an angle (*) between a traveling direction of light reflected by the pupil reconstruction mirror and a direction from the pupil reconstruction mirror (e.g., the center position) toward the image extractor (e.g., the center position).

The following inequality may be satisfied:

$$0 \leq \vert γ \vert \leq 5 .$$

To achieve an optical system with high light utilization efficiency, each condition may hold for the principal ray at the central angle of view. Each condition may be satisfied for the principal ray at the total angle of view. Each condition may be satisfied for all light rays from the projection unit 120.

In each embodiment, to achieve an optical system with high light utilization efficiency, the angle θ (°) between the first mirror and the second mirror in the first cross section may satisfy the following inequality:

$$50 \leq \vert θ \vert \leq 70 .$$

The angle θ (°) may satisfy the following inequality:

$$55 \leq \vert θ \vert \leq 65 .$$

The angle θ (°) may satisfy the following equation:

$$\vert θ \vert = 60 .$$

At least two mirror groups (mirror pairs) that satisfy each inequality may be included. The angle between the direction of the angle bisector of the mirror groups and the traveling direction of the projected light may be 90°−|θ|.

Each embodiment can provide an optical system and a display apparatus, each of which has high light utilization efficiency and can form a good image with little light beam leakage (light amount loss).

While the disclosure has described example embodiments, it is to be understood that the disclosure is not limited to the example embodiments. The scope of the following claims is to be accorded the broadest interpretation so as to encompass all such modifications and equivalent structures and functions.

Each embodiment can provide an optical system with high light utilization efficiency.

This application claims the benefit of Japanese Patent Application No. 2024-200088, which was filed on Nov. 15, 2024, and which is hereby incorporated by reference herein in its entirety.

What is claimed is:

1. An optical system comprising:
a projection unit configured to project light from a display element to form a first pupil; and
a light guide element configured to guide light from the projection unit to an eyepoint,
wherein the light guide element includes a reflector configured to form a second pupil at the eyepoint,
wherein the reflector includes a plurality of reflective surface pairs, each consisting of a first reflective surface and a second reflective surface, and wherein in a first cross section including a normal to each of the first reflective surface and the second reflective surface, the following inequalities are satisfied with respect to a principal ray at a central angle of view:
$$0 \leq \vert α \vert \leq 20$$
$$0 \leq \vert β \vert \leq 20$$
where α (°) is an angle between light incident on the first reflective surface and the second reflective surface, and β (°) is an angle between light reflected by the second reflective surface and the first reflective surface.

2. The optical system according to claim 1, wherein the following inequalities are satisfied:
$$0 \leq \vert α \vert \leq 7.5$$
$$0 \leq \vert β \vert \leq 7.5 .$$

3. The optical system according to claim 1, wherein the following equations are satisfied:
$$α = 0$$
$$β = 0.$$

4. The optical system according to claim 1, wherein the inequalities are satisfied for the principal ray over a total angle of view.

5. The optical system according to claim 1, wherein the inequalities are satisfied for all light rays from the projection unit.

6. The optical system according to claim 1, further comprising a light guide unit configured to guide light from the reflector to the eyepoint, wherein each reflective surface pair has a reflectivity three times or more as large as that of the light guiding unit.

7. The optical system according to claim 1, wherein the light guide element has a deflective element that causes the light from the projection unit to be incident parallel to the second reflective surface with respect to the principal ray of the central angle of view.

8. The optical system according to claim 1, further comprising a light guide unit configured to guide light from the reflector to the eyepoint,
wherein the following inequality is satisfied:
$$0 \leq \vert γ \vert \leq 10$$
where γ is an angle (°) between a traveling direction of the light reflected by the reflector and a direction from the reflector toward the light guide unit in the first cross section.

9. The optical system according to claim 1, wherein the following inequality is satisfied:
$$0.5 < A 2 / A 1 < 2.0$$
where A1 (mm) is an air-equivalent distance from the reflector to the first pupil, and A2 (mm) is an air-equivalent distance from the reflector to the eyepoint.

10. The optical system according to claim 1, wherein the projection unit forms the first pupil inside the light guide element.

11. The optical system according to claim 1, wherein a tilt of each of the plurality of reflective surface pairs changes according to a position in the first cross section.

12. The optical system according to claim 11, wherein each of the plurality of reflective surface pairs has an arc shape with a center on a side close to the first pupil in the first cross section.

13. The optical system according to claim 11, wherein the plurality of reflective surface pairs include a reflective surface pair arranged so that a curvature is zero.

14. The optical system according to claim 1, wherein the plurality of reflective surface pairs include a first reflective surface pairs arranged in a first row and a second reflective surface pairs arranged in a second row in the first cross section.

15. The optical system according to claim 14, wherein the first reflective surface pair reflects S-polarized light, and the second reflective surface pair reflects P-polarized light.

16. An optical system comprising:
a projection unit configured to project light from a display element to form a first pupil; and
a light guide element configured to guide light from the projection unit to an eyepoint,
wherein the light guide element includes a reflector configured to form a second pupil at the eyepoint,
wherein the reflector includes a plurality of reflective surface pairs, each consisting of a first reflective surface and a second reflective surface, and
wherein in a first cross section including a normal to each of the first reflective surface and the second reflective surface, the following inequality is satisfied:
$$50 \leq \vert θ \vert \leq 70$$
where θ (°) is an angle between the first reflective surface and the second reflective surface.

17. The optical system according to claim 16, wherein an angle between a direction of an angle bisector of each reflective surface pair and a propagation direction of projected light is 90°−|θ|.

18. The optical system according to claim 16, wherein a tilt of each of the plurality of reflective surface pairs in the first cross section changes according to a position.

19. The optical system according to claim 16, wherein the plurality of reflective surface pairs include first reflective surface pairs arranged in a first row and second reflective surface pairs arranged in a second row in the first cross section.

20. A display apparatus comprising:
an optical system; and
the display element,
wherein the optical system includes:
a projection unit configured to project light from a display element to form a first pupil, and
a light guide element configured to guide light from the projection unit to an eyepoint,
wherein the light guide element includes a reflector configured to form a second pupil at the eyepoint,
wherein the reflector includes a plurality of reflective surface pairs, each consisting of a first reflective surface and a second reflective surface, and
wherein in a first cross section including a normal to each of the first reflective surface and the second reflective surface, the following inequalities are satisfied with respect to a principal ray at a central angle of view:
$$0 \leq \vert α \vert \leq 20$$
$$0 \leq \vert β \vert \leq 20$$
where α (*) is an angle between light incident on the first reflective surface and the second reflective surface, and β (*) is an angle between light reflected by the second reflective surface and the first reflective surface.
